(19) United States
(12) Patent Application Publication
(10) Pub. No.: US 2006/0256858 A1
(43) Pub. Date: Nov. 16, 2006

(54) Method and system for rate control in a video encoder

(76) Inventor: Douglas Chin, Haverhill, MA (US)

Correspondence Address: MCANDREWS HELD & MALLOY, LTD, 500 WEST MADISON STREET, SUITE 3400, CHICAGO, IL, 60661, US

(21) Appl. No.: 11/409,280

(22) Filed: Apr. 21, 2006

Related U.S. Application Data
(60) Provisional application No. 60/681,326, filed on May 16, 2005.

(51) Int. Cl. H04N 11/04; H04B 1/66; H04N 11/02; H04N 7/12

(52) U.S. Cl. 375/240.03; 375/240.24

(57) ABSTRACT

Presented herein are systems, methods, and apparatus for real-time high definition television encoding. In one embodiment, there is a method for encoding video data. The method comprises estimating amounts of data for encoding a plurality of pictures in parallel; generating a plurality of target rates corresponding to the plurality of pictures based on the estimated amounts of data for encoding the plurality of pictures; and lossy compressing the plurality of pictures based on the target rates corresponding to the plurality of pictures.

### RELATED APPLICATIONS

This application claims priority to and claims benefit from: U.S. Provisional Patent Application Ser. No. 60/681,326, entitled “METHOD AND SYSTEM FOR RATE CONTROL IN A VIDEO ENCODER” and filed on May 16, 2005.

### FEDERALLY SPONSORED RESEARCH OR DEVELOPMENT

Not Applicable

### MICROFICHE/COPYRIGHT REFERENCE

Not Applicable

### BACKGROUND OF THE INVENTION

Advanced Video Coding (AVC) (also referred to as H.264 and MPEG-4, Part 10) can be used to compress high definition television content for transmission and storage, thereby saving bandwidth and memory. However, encoding in accordance with AVC can be computationally intense.

In certain applications, live broadcasts for example, it is desirable to compress high definition television content in accordance with AVC in real time. However, the computationally intense nature of AVC operations in real time may exhaust the processing capabilities of certain processors. Parallel processing may be used to achieve real time AVC encoding, where the AVC operations are divided and distributed to multiple instances of hardware that perform the distributed AVC operations, simultaneously.

Ideally, the throughput can be multiplied by the number of instances of the hardware. However, in cases where a first operation is dependent on the results of a second operation, the first operation may not be executable simultaneously with the second operation. In contrast, the performance of the first operation may have to wait for completion of the second operation.

AVC uses temporal coding to compress video data. Temporal coding divides a picture into blocks and encodes the blocks using similar blocks from other pictures, known as reference pictures. To achieve the foregoing, the encoder searches the reference picture for a similar block. This is known as motion estimation. At the decoder, the block is reconstructed from the reference picture. However, the decoder uses a reconstructed reference picture. The reconstructed reference picture is different, albeit imperceptibly, from the original reference picture. Therefore, the encoder uses encoded and reconstructed reference pictures for motion estimation.

Using encoded and reconstructed reference pictures for motion estimation causes encoding of a picture to be dependent on the encoding of the reference pictures. This is can be disadvantageous for parallel processing.

Additional limitations and disadvantages of conventional and traditional approaches will become apparent to one of ordinary skill in the art through comparison of such systems with the present invention as set forth in the remainder of the present application with reference to the drawings.

### BRIEF SUMMARY OF THE INVENTION

Presented herein are systems, methods, and apparatus for encoding video data in real time, as shown in and/or described in connection with at least one of the figures, as set forth more completely in the claims.

These and other advantages and novel features of the present invention, as well as illustrated embodiments thereof will be more fully understood from the following description and drawings.

### BRIEF DESCRIPTION OF SEVERAL VIEWS OF THE DRAWINGS

FIG. 1 is a block diagram of an exemplary system for encoding video data in accordance with an embodiment of the present invention;

FIG. 2 is a flow diagram for encoding video data in accordance with an embodiment of the present invention;

FIG. 3 is a block diagram of a system for encoding video data in accordance with an embodiment of the present invention;

FIG. 4 is a flow diagram for generating a quantization map in accordance with an embodiment of the present invention;

FIG. 5 is a block diagram of an exemplary video classification engine in accordance with an embodiment of the present invention; and

FIG. 6 is a block diagram describing an exemplary distribution of pictures in accordance with an embodiment of the present invention.

### DETAILED DESCRIPTION OF THE INVENTION

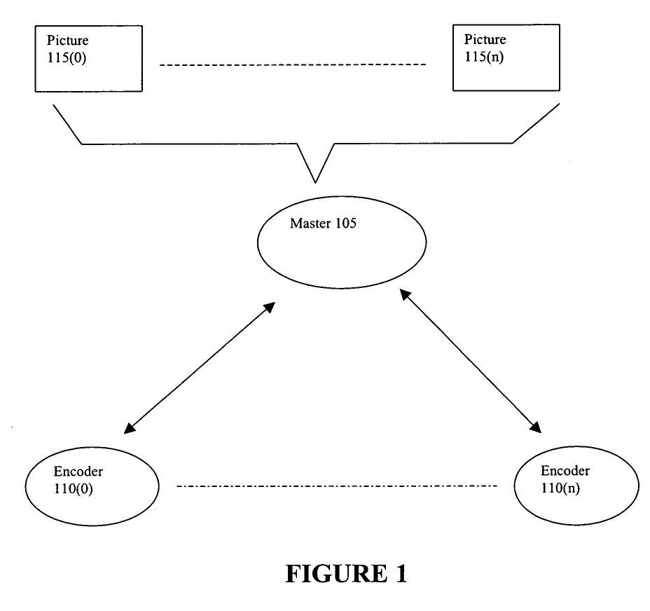

Referring now to FIG. 1, there is illustrated a block diagram of an exemplary system for encoding video data in accordance with an embodiment of the present invention. The video data comprises a plurality of pictures 115(0) . . . 115(n). The system comprises a plurality of encoders 110(0) . . . 110(n). The plurality of encoders 110(0) . . . 110(n) estimate amounts of data for encoding a corresponding plurality of pictures 115(0) . . . 115(n), in parallel. A master 105 generates a plurality of target rates corresponding to the pictures and the encoders. The encoders 110(0) . . . 110(n) lossy compress the pictures based on the corresponding target rates.

The master 105 can receive the video data for compression. Where the master 105 receives the video data for compression, the master 105 can divide the video data among the encoders 110(0) . . . 110(n), provide the divided portions of the video data to the different encoders, and play a role in controlling the rate of compression.

In certain embodiments, the compressed pictures are returned to the master 105. The master 105 collates the compressed pictures, and either writes the compressed video data to a memory (such as a Hard Disk) or transmits the compressed video data over a communication channel.

The master 105 plays a role in controlling the rate of compression by each of the encoders 110(0) . . . 110(n). Compression standards, such as AVC, MPEG-2, and VC-1 use both lossless and lossy compression to encode video data. Moreover, compression may be achieved by allowing loss that is not perceptually important. In lossless compression, information from the video data is not lost from the compression. However, in lossy compression, some information from the video data is lost to improve compression. An example of lossy compression is the quantization of transform coefficients.

Lossy compression involves trade-off between quality and compression. Generally, the more information that is lost during lossy compression, the better the compression rate, but, the more the likelihood that the information loss perceptually changes the video data and reduces quality.

The encoders 110 perform a pre-encoding estimation of the amount of data for encoding pictures 115. For example, the encoders 110 can generate normalized estimates of the amount of data for encoding the pictures 115, by estimating the amount of data for encoding the pictures 115 with a given quantization parameter.

Based on the estimates of the amount of data for encoding the pictures 115, the master 105 can provide a target rate to the encoders 110 for compressing the pictures 115. The encoders 110(0) . . . 110(n) can adjust certain parameters that control lossy compression to achieve an encoding rate that is close, if not equal, to the target rate.

The estimate of the amount of data for encoding a picture 115 can be based on a variety of factors. These qualities can include, for example, content sensitivity, measures of complexity of the pictures and/or the blocks therein, and the similarity of blocks in the pictures to candidate blocks in reference pictures. Content sensitivity measures the likelihood that information loss is perceivable, based on the content of the video data. For example, in video data loss is more noticeable in some types of texture than in others.

In certain embodiments of the present invention, the master 105 can also collect statistics of past target rates and actual rates under certain circumstances. This information can be used as feedback to bias future target rates. For example, where the actual target rates have been consistently exceeded by the actual rates in the past under a certain circumstance, the target rate can be reduced in the future under the same circumstances.

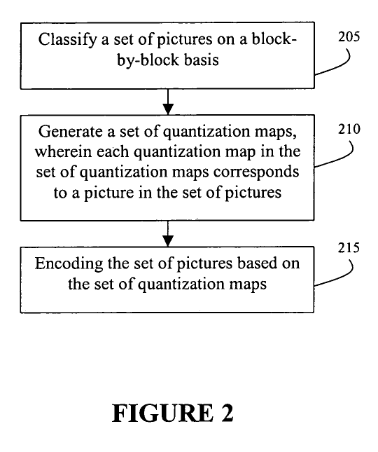

Referring now to FIG. 2, there is illustrated a flow diagram for encoding video data in accordance with an embodiment of the present invention. At 205, the encoders 110(0) . . . 110(n) each estimates the amounts of data for encoding pictures 115(0) . . . 115(n) in parallel.

At 210, the master 105 generates target rates for each of the pictures 115(0) . . . 115(n) based on the estimated amounts during 205. At 215, the encoders 110(0) . . . 110(n) lossy compress the pictures 115(0) . . . 115(n) based on the target rates corresponding to the plurality of pictures.

Embodiments of the present invention will now be presented in the context of an exemplary video encoding standard, Advanced Video Coding (AVC) (also known as MPEG-4, Part 10, and H.264). A brief description of AVC will be presented, followed by embodiments of the present invention in the context of AVC. It is noted, however, that the present invention is by no means limited to AVC and can be applied in the context of a variety of the encoding standards.

The standards encode video on a picture-by-picture basis, and encode pictures on a macroblock by macroblock basis. The H.264 standard specifies the use of spatial prediction, temporal prediction, transformations, lossy compression, and lossless compression to compress the macroblocks 320.

Unless otherwise specified, the pixel dimensions for a unit, such as a macroblock or partition, shall refer to the dimensions of the luma pixels of the unit. Also, and unless otherwise specified, a unit with a given pixel dimension shall also include the corresponding chroma red and chroma blue pixels that overlay the luma pixels. The dimensions of the chroma red and chroma blue pixels for the unit depend on whether MPEG 4:2:0, MPEG 4:2:2 or other format is used, and may differ from the dimensions of the luma pixels.

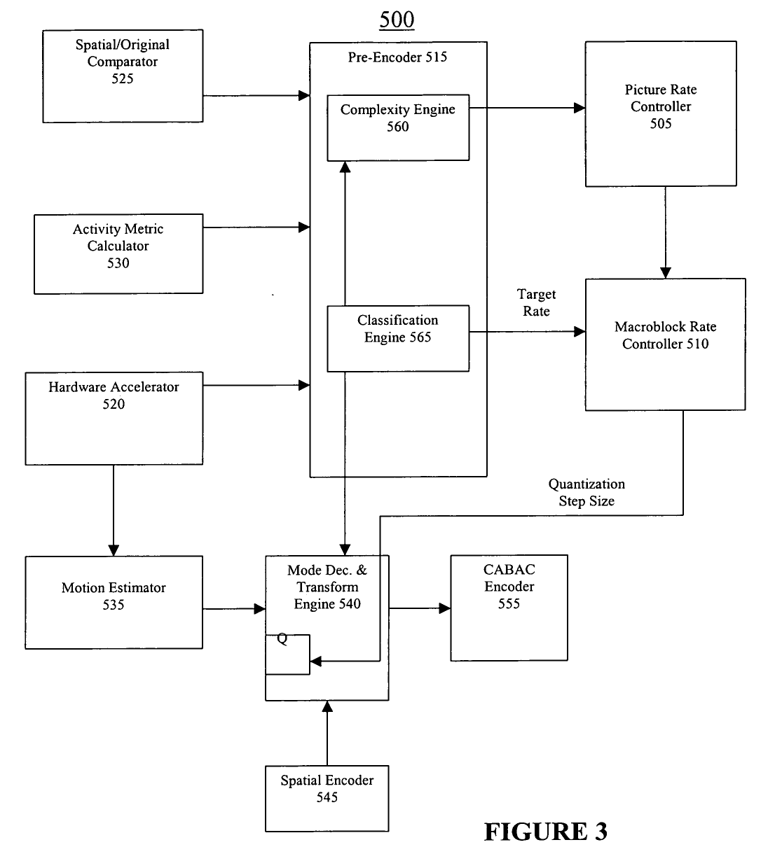

Referring now to FIG. 3, there is illustrated a block diagram of an exemplary system 500 for encoding video data in accordance with an embodiment of the present invention. The system 500 comprises a picture rate controller 505, a macroblock rate controller 510, a pre-encoder 515, hardware accelerator 520, spatial from original comparator 525, an activity metric calculator 530, a motion estimator 535, a mode decision and transform engine 540, and a CABAC encoder 555.

The picture rate controller 505 can comprise software or firmware residing on the master 105. The macroblock rate controller 510, pre-encoder 515, spatial from original comparator 525, mode decision and transform engine 540, spatial predictor 545, and CABAC encoder 555 can comprise software or firmware residing on each of the encoders 110(0) . . . 110(n). The pre-encoder 515 includes a complexity engine 560 and a classification engine 565. The hardware accelerator 520 can either be a central resource accessible by each of the encoders 110, or decentralized hardware at the encoders 110.

The hardware accelerator 520 can search the original reference pictures for candidate blocks CB that are similar to blocks in the pictures 115 and compare the candidate blocks CB to the blocks in the pictures. The pre-encoder 515 estimates the amount of data for encoding pictures 115. The hardware accelerator 520 may be a motion estimator that works on original source pictures with macroblock granularity and provides candidate vector information to the encoder and the rate control module

The pre-encoder 515 comprises a complexity engine 560 that estimates the amount of data for encoding the pictures 115, based on the results of the hardware accelerator 520. The pre-encoder 515 also comprises a classification engine 565. The classification engine 565 may classify certain content from the pictures 115 that is perceptually sensitive, such as human faces, where additional data for encoding is desirable. Likewise, the classification engine 565 may also classify things that are perceptually insensitive and reduce the bits that would have been allocated to them.

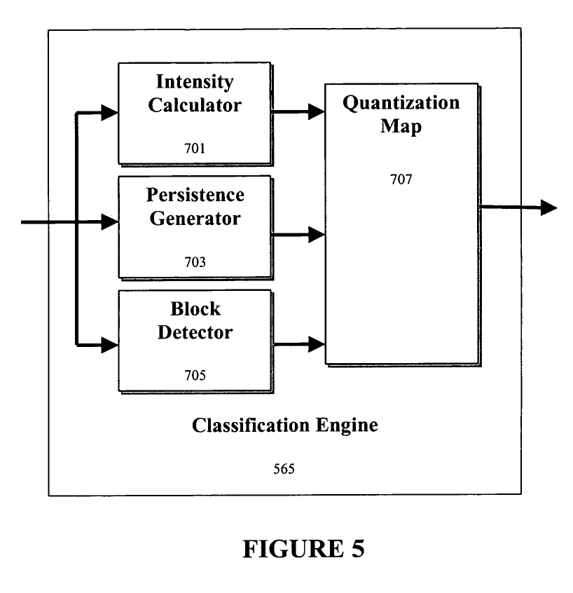

The classification engine 565 is described in further detail with respect to FIG. 5.

Where the classification engine 565 classifies the perceptual sensitivity of certain content from pictures 115, the classification engine 565 indicates the foregoing to the complexity engine 560. The complexity engine 560 can adjust the estimate of data for encoding the pictures 115. The complexity engine 565 provides the estimate of the amount of data for encoding the pictures by providing an amount of data for encoding the picture with a nominal quantization parameter Qp. It is noted that the nominal quantization parameter Qp is not necessarily the quantization parameter used for encoding pictures 115.

The picture rate controller 505 provides a target rate to the macroblock rate controller 510. The motion estimator 535 searches the vicinities of areas in the reconstructed reference picture that correspond to the candidate blocks CB, for reference blocks P that are similar to the blocks in the plurality of pictures.

The search for the reference blocks P by the motion estimator 535 can differ from the search by the hardware accelerator 520 in a number of ways. For example, the hardware accelerator 520 can use a 16×16 block, while the motion estimator 535 divides the 16×16 block into smaller blocks, such as 8×8 or 4×4 blocks. Also, the motion estimator 535 can search the reconstructed reference picture 115RRP with ¼ pixel resolution.

The spatial predictor 545 performs the spatial predictions for blocks. The mode decision & transform engine 540 determines whether to use spatial encoding or temporal encoding, and calculates, transforms, and quantizes the prediction error E from the reference block. The complexity engine 560 indicates the complexity of each macroblock 320 at the macroblock level based on the results from the hardware accelerator 520, while the classification engine 565 indicates whether a particular macroblock contains sensitive content. Based on the foregoing, the complexity engine 560 provides an estimate of the amount of bits that would be required to encode the macroblock 320. The macroblock rate controller 510 determines a quantization parameter and provides the quantization parameter to the mode decision & transform engine 540. The mode decision & transform engine 540 comprises a quantizer Q. The quantizer Q uses the foregoing quantization parameter to quantize the transformed prediction error.

The mode decision & transform engine 540 provides the transformed and quantized prediction error to the CABAC encoder 555. The CABAC encoder 555 converts this to CABAC data. The actual amount of data for coding the macroblock 320 can also be provided to the picture rate controller 505.

In certain embodiments of the present invention, the picture rate controller 505 can record statistics from previous pictures, such as the target rate given and the actual amount of data encoding the pictures. The picture rate controller 505 can use the foregoing as feedback. For example, if the target rate is consistently exceeded by a particular encoder, the picture rate controller 505 can give a lower target rate

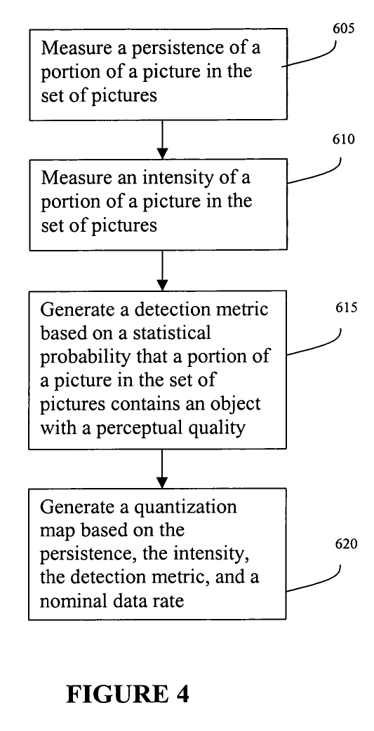

FIG. 4 is a flow diagram for generating a quantization map in accordance with an embodiment of the present invention. A persistence of a portion of a picture in the set of pictures is measured at 605. A finer quantization will be used when the persistence is relatively long and unchanging. Likewise, a coarser quantization will be used when the persistence is relatively short. Objects that persist and are not undergoing transformation that are hard to predict may be given more bits. If the persistent area is changing, it may be given fewer bits. This may be based on the quality of the prediction.

An intensity and texture of a portion of a picture in the set of pictures may be measured at 610. A finer quantization will be used when the intensity is relatively low. Likewise, a coarser quantization will be used when the intensity is relatively high. Texture may also be estimated by a dynamic range. Fore example, lowering QP will preserve subtle textures.

At 615, a detection metric is generated based on a statistical probability that a portion of a picture in the set of pictures contains an object with a perceptual quality. A finer quantization is used when the perceptual quality of the object is important to a viewer of the picture. For example, facial expression adds to the content of a videoconference. Therefore, skin has a perceptual quality that is important to the viewer. Objects that do not add to the content of a picture may have detail, but the representation of that detail is less important to the viewer. For example, a brick wall behind a speaker is not important for the understanding of the speaker.

At 620, a quantization map is generated based on the persistence, the intensity, the detection metric, and a nominal data rate. A complexity engine can use the nominal data rate and deviations to the nominal data rate based on the persistence, the intensity, and the detection metric. These factors can be determined prior to encoding in a phase called pre-coding. Pre-coding of pictures may occur in parallel by using a plurality of encoders. Quantization maps from a plurality of pre-coded picture can be considered at the same time to determine a distribution of bit allocation for portions of pictures over time.

Referring now to FIG. 5, a block diagram of an exemplary video classification engine is shown. The classification engine 565 comprises an intensity calculator 701, a persistence generator 703, a block detector 705, and a quantization map 707.

The intensity calculator 701 can determine the dynamic range of the intensity by taking the difference between the minimum luma component and the maximum luma component in a macroblock.

For example, the macroblock may contain video data having a distinct visual pattern where the color and brightness does not vary significantly. The dynamic range can be quite low, and minor variations in the visual pattern are difficult to capture without the allocation of enough bits during the encoding of the macroblock. An indication of how many bits you should be adding to the macroblock can be based on the dynamic range. A low dynamic range scene may require a negative QP shift such that more bits are allocated to preserve the texture and patterns.

A macroblock that contains a high dynamic range may also contain sections with texture and patterns, but the high dynamic range can spatially mask out the texture and patterns. Dedicating fewer bits to the macroblock with the high dynamic range can result in little if any visual degradation.

Scenes that have high intensity differentials or dynamic ranges can be given fewer bits comparatively. The perceptual quality of the scene can be preserved since the fine detail, that would require more bits, may be imperceptible. A high dynamic range will lead to a positive QP shift for the macroblock.

For lower dynamic range macroblocks, more bits can be assigned. For higher dynamic range macroblocks, fewer bits can be assigned.

The human visual system can perceive intensity differences in darker regions more accurately than in brighter regions. A larger intensity change is required in brighter regions in order to perceive the same difference. The dynamic range can be biased by a percentage of the lumma maximum to take into account the brightness of the dynamic range. This percentage can be determined empirically. Alternatively, a ratio of dynamic range to lumma maximum can be computed and output from the intensity calculator 701.

The persistence generator 703 can estimate the persistence of a macroblock based on the sum of absolute difference (SAD) from motion estimation. A high persistence can have a relatively low SAD since it can be well predicted. Elements of a scene that are persistent can be more noticeable. Whereas, elements of a scene that appear for a short period may have details that are less noticeable. More bits can be assigned when a macroblock is persistent. Macroblocks that persists for several frames can be assigned more bits since errors in those macroblocks are going to be more easily perceived.

A block of pixels can be declared part of a target region by the block detector 705 if enough of the pixels fall within a statistically determined range of values. For example in an 8×8 block of pixels in which skin is being detected, an analysis of color on a pixel-by-pixel basis can be used to determine a probability that the block can be classified as skin.

When the block detector 705 has classified a target object, quantization levels can be adjusted to allocate more or less resolution to the associated block(s). For the case of skin detection, a finer resolution can be desired to enhance human features. The quantization parameter (QP) can be adjusted to change bit resolution at the quantizer in a video encoder. Shifting QP lower will add more bits and increase resolution. If the block detector 105 has detected a target object that is to be given higher resolution, the QP of the associated block in the quantization map 707 will decreased. If the block detector 705 has detected a target object that is to be given a lower resolution, the QP of the associated block in the quantization map 707 will increased. Target objects that can receive lower resolution may include trees, sky, clouds, or water if the detail in these objects is unimportant to the overall content of the picture.

The classification engine 565 can determine relative bit allocation. The classification engine 565 can elect a relative QP shift value for every macroblock during pre-encoding. Relative to a nominal QP the current macroblock can have a QP shift that indicates encoding with quantization level that is deviated from an average. A lower QP (negative QP shift) indicates more bits are being allocated, a higher QP (positive QP shift) indicates less bits are being allocated.

The QP shift for intensity, persistence, and block detection can be independently calculated. The quantization map 707 can be generated a priori and can be used by a rate controller during the encoding of a picture. When coding the picture, a nominal QP will be adjusted to try to stay on a desired “rate profile”, and the quantization map 707 can provide relative shifts to the nominal QP.

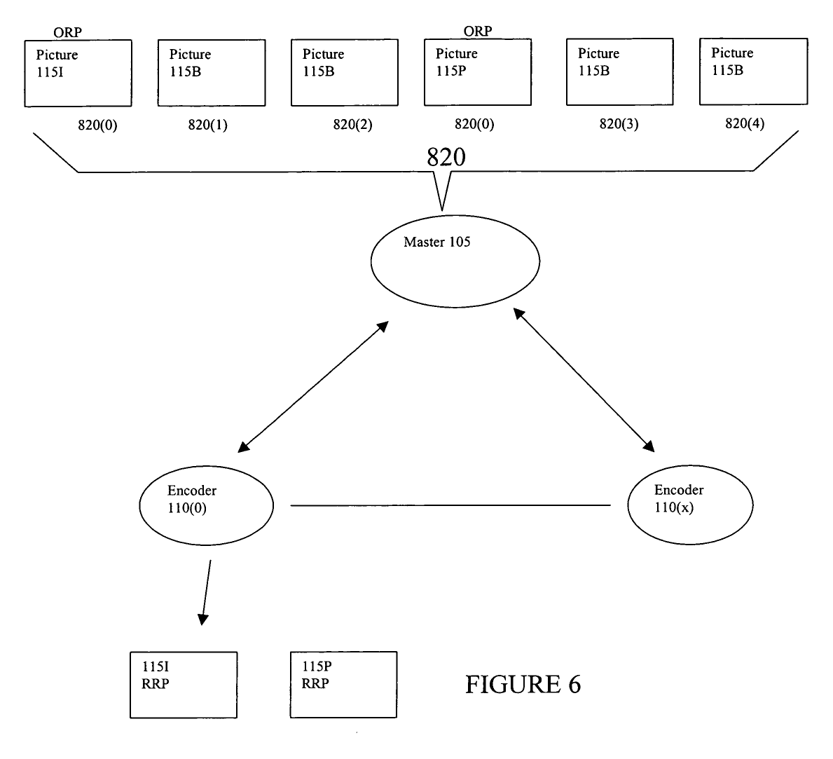

Referring now to FIG. 6, there is illustrated a block diagram of an exemplary distribution of pictures by the master 105 to the encoders 110(0) . . . 110(x). The master 105 can divide the pictures 115 into groups 820, and the groups into sub-groups 820(0) . . . 820(n). Certain pictures, intra-coded pictures 115I, are not temporally coded, certain pictures, predicted-pictures 115P, are temporally encoded from one reconstructed reference pictures 115RRP, and certain pictures, bi-directional pictures 115B, are encoded from two or more reconstructed reference pictures 115RRP. In general, intra-coded pictures 115I take the least processing power to encode, while bi-directional pictures 115B take the most processing power to encode.

In an exemplary case, the master 105 can designate that the first picture 115 of a group 820 is an intra-coded picture 115I, every third picture, thereafter, is a predicted picture 115P, and that the remaining pictures are bi-directional pictures 115B. Empirical observations have shown that bi-directional pictures 115B take about twice as much processing power as predicted pictures 115P. Accordingly, the master 105 can provide the intra-coded picture 115I, and the predicted pictures 115P to one of the encoders 110, as one sub-group 820(0), and divide the bi-directional pictures 115B among other encoders 110 as four sub-groups 820(1) . . . 820(4).

The encoders 110 can search original reference pictures 115ORP for candidate blocks that are similar to blocks in the plurality of pictures, and select the candidate blocks based on comparison between the candidate blocks and the blocks in the pictures. The encoders 110 can then search the vicinity of an area in the reconstructed reference picture 115RRP that corresponds to the area of the candidate blocks in the original reference picture 115ORP for a reference block.

The embodiments described herein may be implemented as a board level product, as a single chip, application specific integrated circuit (ASIC), or with varying levels of the decoder system integrated with other portions of the system as separate components.

The degree of integration of the decoder system may primarily be determined by the speed and cost considerations. Because of the sophisticated nature of modern processor, it is possible to utilize a commercially available processor, which may be implemented external to an ASIC implementation.

If the processor is available as an ASIC core or logic block, then the commercially available processor can be implemented as part of an ASIC device wherein certain functions can be implemented in firmware. For example, the macroblock rate controller 510, pre-encoder 515, spatial from original comparator 525, activity metric calculator 530, motion estimator 535, mode decision and transform engine 540, and CABAC encoder 555 can be implemented as firmware or software under the control of a processing unit in the encoder 110. The picture rate controller 505 can be firmware or software under the control of a processing unit at the master 105. Alternatively, the foregoing can be implemented as hardware accelerator units controlled by the processor.

While the present invention has been described with reference to certain embodiments, it will be understood by those skilled in the art that various changes may be made and equivalents may be substituted without departing from the scope of the present invention.

Additionally, many modifications may be made to adapt a particular situation or material to the teachings of the present invention without departing from its scope. For example, although the invention has been described with a particular emphasis on the AVC encoding standard, the invention can be applied to a video data encoded with a wide variety of standards.

Therefore, it is intended that the present invention not be limited to the particular embodiment disclosed, but that the present invention will include all embodiments falling within the scope of the appended claims.

1. A method for encoding video data, said method comprising:
classifying a set of pictures on a block-by-block basis;
generating a set of quantization maps for the set of pictures; and
encoding the set of pictures based on the set of quantization maps.

2. The method of claim 1, wherein classifying the set of pictures is a parallel process.

3. The method of claim 1, wherein encoding the set of pictures is a parallel process.

4. The method of claim 1, wherein classifying further comprises:
measuring a persistence of a portion of a picture in the set of pictures.

5. The method of claim 4, wherein a quantization map that corresponds to the picture comprises a relative quantization parameter that corresponds to the portion, and wherein a finer quantization is indicated when the persistence is relatively long.

6. The method of claim 1, wherein classifying further comprises:
measuring an intensity of a portion of a picture in the set of pictures.

7. The method of claim 6, wherein a quantization map that corresponds to the picture comprises a relative quantization parameter that corresponds to the portion and wherein the relative quantization parameter indicates a finer quantization when the intensity is relatively low.

8. The method of claim 1, wherein classifying further comprises:
generating a detection metric based on a statistical probability that a portion of a picture in the set of pictures contains an object with a perceptual quality.

9. The method of claim 8, wherein a quantization map that corresponds to the picture comprises a relative quantization parameter that corresponds to the portion and wherein the relative quantization parameter indicates a finer quantization when the perceptual quality of the object is important to a viewer of the picture.

10. The method of claim 8, wherein a quantization map that corresponds to the picture comprises a relative quantization parameter that corresponds to the portion and wherein the relative quantization parameter indicates a coarser quantization when the perceptual quality of the object is unimportant to a viewer of the picture.

11. The method of claim 8, wherein a quantization map is updated based on a comparison of a feedback signal to the statistical probabilities.

12. The method of claim 11, wherein the quantization map adjusts a nominal quantization parameter which is adjusted to obtain a desired rate profile.

13. A system for encoding video data, said system comprising:
a master; and
a plurality of encoders, wherein each encoder comprises:
a classification engine for classifying a picture on a block-by-block basis;
a quantization map for storing a set of relative quantization parameters according to the classification;
a quantizer for lossy compressing the picture, wherein a quantization is controlled by the master and based on the quantization maps from other encoders.

14. The system of claim 13, wherein each encoder further comprises:
an intensity calculator for measuring an intensity of a portion of the picture, wherein a relative quantization parameter in the quantization map indicates a finer quantization when the intensity is relatively low.

15. The system of claim 13, wherein each encoder further comprises:
a persistence generator for measuring a persistence of a portion of the picture, wherein a relative quantization parameter in the quantization map indicates a finer quantization when the persistence is relatively long.

16. The system of claim 13, wherein each encoder further comprises:
a block detector for generating a detection metric based on a portion of the picture, wherein a relative quantization parameter in the quantization map indicates a finer quantization when an object of perceptual significance is detected according to the detection metric.

17. The system of claim 15, wherein the relative quantization parameter in the quantization map indicates a coarser quantization when an object of perceptual insignificance is detected according to the detection metric.

18. The system of claim 13, wherein the quantization map adjusts a nominal quantization parameter which is adjusted to obtain a desired rate profile.
